(19) United States
(12) Patent Application Publication
(10) Pub. No.: US 2023/0234362 A1
(43) Pub. Date: Jul. 27, 2023

(54) FLUIDIC INTERFACES WITH SHUTTER LOCKS

(71) Applicant: Hewlett-Packard Development Company, L.P., Spring, TX (US)

(72) Inventors: Kevin Ken Kuramura, Portland, OR (US); Kevin Lo, Vancouver, WA (US)

(21) Appl. No.: 17/918,869

(22) PCT Filed: Apr. 15, 2020
(86) PCT No.: PCT/US2020/028351

§ 371 Date: Oct. 13, 2022

(51) Int. Cl. B41J 2/175; B41J 29/54

(52) U.S. Cl. CPC B41J 2/17523; B41J 29/54; B41J 2/17509

(57) ABSTRACT

Examples of a fluidic interface for a printing device are described. In some examples, the fluidic interface may include a shutter lock to prevent movement of a shutter covering a needle to engage a print substance supply. In some examples, the fluidic interface may also include a supply key opening to receive a supply key of the print substance supply that engages the shutter lock to permit movement of the shutter to expose the needle.

### BACKGROUND

A printing device may print on print media. For example, a fluid ejection device may deposit a print substance, such as ink, on the print media. In some examples, the fluid ejection device may include a fluidic die to deposit the print substance on the print media. The printing device may also include a print substance reservoir.

### BRIEF DESCRIPTION OF THE DRAWINGS

Various examples will be described below by referring to the following figures.

FIG. 1 is a section view illustrating an example of a shutter lock for a fluidic interface of a printing device;

FIG. 2 is an upper perspective view of an example of a fluidic interface of a printing device with a shutter lock;

FIGS. 3A and 3B are front views of an example of a fluidic interface of a printing device with a shutter lock;

FIGS. 4A and 4B are section views of an example of a fluidic interface with a sliding shutter lock;

FIG. 5 is a section view of an example of a fluidic interface with a rotational shutter lock; and

FIG. 6 illustrates an example of a printing device 602 with a plurality of fluidic interfaces.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

### DETAILED DESCRIPTION

Printing devices may deposit a liquid print substance (also referred to as printing fluid) on print media. In some examples, the printing device may include a fluid ejection device that deposits the print substance. A fluid ejection device may include a fluidic die (also referred to as a printhead die) that includes nozzles to eject the print substance.

In some examples, a fluidic interface of the printing device may have a needle that pushes through the fluidic interface of an external print substance supply to create a fluidic connection. The needle may be protected by a spring-loaded shutter to expose the needle when the print substance supply pushes the shutter down.

In some cases, it may be possible to push the shutter down using a finger or other object. In these cases, the presence of positive pressure in the needle may cause the print substance to spill out onto the user, the printing device or the area surrounding the printing device. To prevent this scenario, a passively-operated shutter lock is described herein. The shutter lock may be placed near the shutter at the fluidic interconnect position. This shutter lock may engage the shutter to prevent the shutter from being pushed down. The external print substance supply may include a supply key to push the shutter lock out of the way as the print substance supply is installed on the printing device. Once the shutter lock disengages from the shutter, the shutter may retract from the needle.

In some examples, the print substance may include printing agents or colorants. The printing device may apply the print substance to a substrate. A substrate is a superset of print media, such as plain paper, and can include any suitable object or materials to which a print substance from a printing device is applied including materials, such as powdered build materials, for forming three-dimensional articles. In addition, in some examples, a printing device may print on various media such as inanimate objects, skin, books, wood, plastic, metal, concrete, wallpaper, or other materials. Print substances, including printing agents and colorants, can include liquid inks, or other suitable marking material that may or may not be mixed with fusing agents, detailing agents, or other materials and can be applied to the substrate.

In other examples, the printing device may be a fluid ejection device. For example, the printing device may be used in life-science applications (e.g., lab-on-chip fluidic designs), bio-printing, printed manufacturing features and sensors for additive manufacturing applications. These applications may use a print substance other than ink or toner.

In some cases, the printing device may store the print substance in an internal reservoir. For example, the printing device may include a continuous ink supply system (CISS) for transporting the print substance from the internal reservoir to a fluid ejection device. Accordingly, the internal reservoir may be filled from an external source (referred to herein as a print substance supply) and may provide the print substance to a fluid ejection device (e.g., printhead) in a continuous manner without installation of a new fluid ejection device.

In some examples, the printing device may include multiple print substance reservoirs. For example, different print substance reservoirs may be used for storing print substances of different colors.

The printing device may receive the print substance from an external print substance supply. For example, the print substance supply may be a container for the print substance. The print substance supply may interface with the printing device in a removable manner. For example, the printing device may include a fluidic interface to enable the transfer of the print substance from the print substance supply to the printing device. The print substance supply may be used to refill and enable recovery of the print substance from the internal reservoir of the printing device. When the internal reservoir is refilled, the print substance supply may be removed from the printing device.

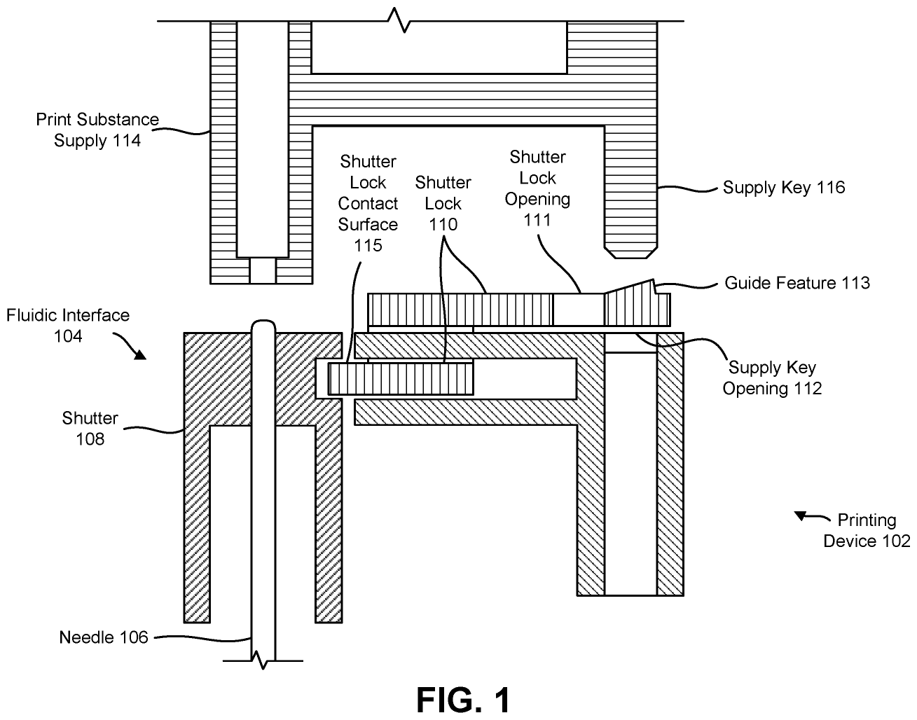

FIG. 1 is a section view illustrating an example of a shutter lock 110 for a fluidic interface 104 of a printing device 102. Examples of printing devices include printers, copiers, fax machines, multifunction devices including additional scanning, copying, and finishing functions, all-in-one devices, pad printers to print images on three dimensional objects, and three-dimensional printers (additive manufacturing devices).

In some examples, the printing device 102 may include a fluid ejection device (not shown) that is used in a fluid ejection application (e.g., thermal inkjet, piezoelectric inkjet, etc.). For example, a print substance may be stored in a print substance reservoir of the printing device 102. The print substance may be transported from the print substance reservoir to a fluid ejection device. In some examples, the fluid ejection device may include a fluidic die that includes nozzles and circuitry to eject the print substance out of the fluid ejection device.

In some examples, the print substance reservoir of the printing device 102 may store the print substance for a continuous ink supply system (CISS). In this case, the print substance may be provided to the fluid ejection device from the print substance reservoir (not shown).

In some examples, the printing device 102 may receive the print substance from a print substance supply 114. For instance, the print substance supply 114 may be a removable external reservoir to supply the print substance to the printing device 102. The print substance supply 114 may attach to the printing device 102 at a fluidic interface 104.

The fluidic interface 104 may include a needle 106. In some examples, the needle 106 may be a fluid transfer needle. For instance, the needle 106 may be hollow with an opening to allow fluid to flow through the needle 106. The print substance may flow through the needle 106 to the print substance reservoir of the printing device 102. The needle 106 may be sized and positioned to push through the fluidic interface of the external print substance supply 114 to create a fluidic connection. Once connected, the print substance may flow from the print substance supply 114 into the printing device 102. In some cases, the print substance may also flow out of the printing device 102 through the needle 106 and into the print substance supply 114.

The fluidic interface 104 may also include a shutter 108. In some examples, the shutter 108 may be a moveable cover that protects the needle 106. The shutter 108 may surround the needle 106 when the shutter 108 is in a first position. The shutter 108 may protect the needle 106 when the print substance supply 114 is not connected to the printing device 102.

In some examples, the shutter 108 may be spring-loaded to conceal the needle 106. For example, the shutter 108 may move along the axis of the needle 106. A force exerted on the shutter 108 (by the print substance supply 114, for instance) may cause the shutter 108 to retract, thus exposing the needle 106. Once the force is removed from the shutter 108, the spring may cause the shutter 108 to return to a position where the needle 106 is covered. When the needle 106 is covered by the shutter 108 fluid flow out of the needle 106 may be prevented. For example, the shutter 108 may include a seal to prevent fluid flow out of the needle 106 when the shutter 108 is extended over the needle 106.

The fluidic interface 104 may include a shutter lock 110 to prevent or limit movement of the shutter 108 covering the needle 106 that engages the print substance supply 114. In some examples, the shutter lock 110 may be a device to enable and disable movement of the shutter 108. In some examples, the shutter lock 110 may contact the shutter 108. This physical contact by the shutter lock 110 may prevent the shutter 108 from retracting from the needle 106.

In the example depicted in FIG. 1, the shutter lock 110 exhibits linear movement. For instance, the shutter lock 110 may slide back and forth to engage and disengage the shutter 108. In the engaged position, a surface of the shutter 108 may contact a shutter lock contact surface 115 to prevent or limit movement of the shutter 108. As the shutter lock 110 slides away from the shutter 108, the contact surfaces separate and the shutter 108 may retract from the needle 106.

In some examples, the shutter lock 110 may be spring-loaded to engage the shutter 108 to prevent the shutter 108 from exposing the needle 106. For example, a compression spring (not shown) may be placed to interact with the shutter lock 110 such that the spring causes the shutter lock 110 to engage the shutter 108 unless a force is applied to the shutter lock 110 to overcome the spring. In other examples, the spring may be a torsion spring, extension spring, leaf spring, etc. In this manner, the shutter lock 110 may be considered a passive mechanism that returns to a default state of engaging the shutter 108 until a force is applied to the shutter lock 110. In other examples, gravity may be used instead of a spring to bias the shutter lock 110 against the shutter 108.

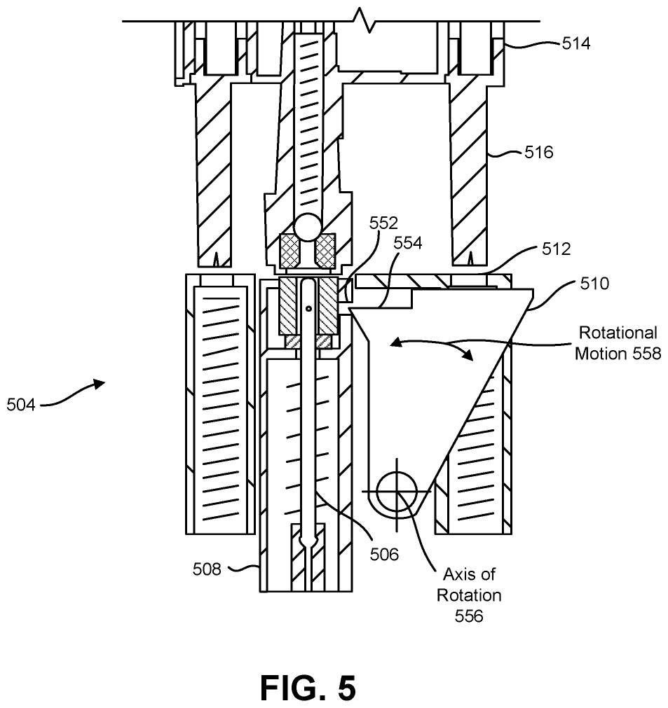

It should be noted that while two separate components of the shutter lock 110 are depicted in the section view of FIG. 1, these components may be connected as a single unit. For example, an upper part of the shutter lock 110 may be exposed to the print substance supply 114. A lower part of the shutter lock 110 may include a projection that engages the shutter 108. The components forming the shutter lock 110 may slide along a track feature of the fluidic interface 104. It should be appreciated that the shutter lock 110 may be implemented in other configurations. For example, FIGS. 1-4B illustrate examples of the shutter lock 110 with linear motion. FIG. 5 illustrates a shutter lock 110 with rotational motion.

The fluidic interface 104 may also include a supply key opening 112 to receive a supply key 116 of the print substance supply 114. The supply key 116 may engage the shutter lock 110 to permit movement of the shutter 108. This movement of the shutter 108 may expose the needle 106. The supply key opening 112 may be an orifice to allow a supply key 116 to pass into the supply key opening 112.

In some examples, the supply key 116 may be attached to the print substance supply 114. The supply key 116 may project from the print substance supply 114. The supply key 116 may be positioned and sized to fit into the supply key opening 112.

Contact of the shutter lock 110 by the supply key 116 may cause the shutter lock 110 to retract from the shutter 108. Once the shutter lock 110 disengages the shutter 108, this permits movement of the shutter 108 to expose the needle 106. The supply key opening 112 may be positioned to allow the supply key 116 to move the shutter lock 110 away from the shutter 108 as the supply key 116 is inserted in the supply key opening 112.

In some examples, the supply key opening 112 may be positioned at least partially under the shutter lock 110 when the shutter lock 110 engages the shutter 108. In other words, when the shutter lock 110 is in an engaged position with the shutter 108, the supply key opening 112 may be located at least partially under a portion of the shutter lock 110. The shutter lock 110 may include an opening 111 to permit passage of the supply key 116. The supply key 116 may be inserted into this shutter lock opening 111. A lateral force of the supply key 116 may cause the shutter lock 110 to slide away from the shutter 108 and to expose the supply key opening 112. In other words, contact of the shutter lock 110 by the supply key 116 may cause the shutter lock 110 to slide away from the shutter 108 and expose the supply key opening 112 to the supply key 116.

In some examples, the shutter lock 110 may include a guide feature 113 to assist in retracting the shutter lock 110 in response to contact by the supply key 116. For example, the top of the shutter lock 110 may include an angles (e.g., chamfer or ramp) feature (referred to as guide feature 113) near the shutter lock opening 111. The guide feature 113 may enable lead-in of the supply key 116 and translational force against the shutter lock 110 (e.g., to the right) as the supply key 116 is installed. In other examples, the guide feature 113 may be located on the supply key 116.

In an example, a user holding the print substance supply 114 may align the print substance supply 114 to the printing device 102 using alignment features (not shown) on the printing device 102 and/or the print substance supply 114. This may cause the supply key 116 to align with the supply key opening 112. However, the shutter lock 110 in the engaged position may block (at least partially) the supply key 116 from the supply key opening 112. In other words, the supply key 116 and the shutter lock opening 111 may not be initially aligned. The downwards motion by the supply key 116 may act on the angled guide feature 113 present on the shutter lock 110, causing the shutter lock 110 to slide over, thereby aligning the supply key 116 to the shutter lock opening 111. In other words, a downward motion rather than a lateral motion (e.g., left to right motion) applied by the user to the print substance supply 114 may cause the shutter lock 110 to move laterally. Once the shutter lock 110 slides away from the shutter 108, the supply key opening 112 may be exposed to the supply key 116. The user may then insert the supply key 116 into the supply key opening 112 and press the print substance supply 114 onto the shutter 108, which retracts from the needle 106.

The supply key 116 may be inserted into a cavity aligned with the supply key opening 112. As the supply key 116 is inserted into the supply key opening and cavity, the print substance supply 114 may press against the shutter 108, which retracts from the needle 106. As the shutter 108 moves, the needle 106 may enter the print substance supply 114 forming a fluid connection.

As the supply key 116 is removed from the supply key opening 112, the print substance supply 114 also disengages from the shutter 108. The shutter 108 returns to cover the needle 106. As the supply key 116 is removed from the supply key opening 112, the shutter lock 110 slides back to engage the shutter 108.

In some examples, the supply key opening 112 may be formed with geometry (e.g., the shape of the supply key opening 112) to differentiate supply keys 116 associated with different print substance supply types. For example, the supply key opening 112 may receive a supply key 116 having a geometry that is compatible with the geometry of the supply key opening 112. In some examples, the geometry of the supply key opening 112 may differentiate between colors of print substance, qualities of print substance, manufacturers of print substance, etc.

In some examples, the printing device 102 may include a plurality of fluidic interfaces 104 coupled to a plurality of print substance reservoirs. For example, for a printing device 102 that prints in color, the printing device 102 may include four print substance reservoirs corresponding to black, magenta, cyan and yellow print substances. Each fluidic interface 104 may include a supply key opening 112 having a geometry that differs from other supply key openings 112 to differentiate supply keys 116 associated with different print substance supply colors. In this case, the supply keys 116 may be referred to as color keys because a given supply key 116 is associated with a particular color.

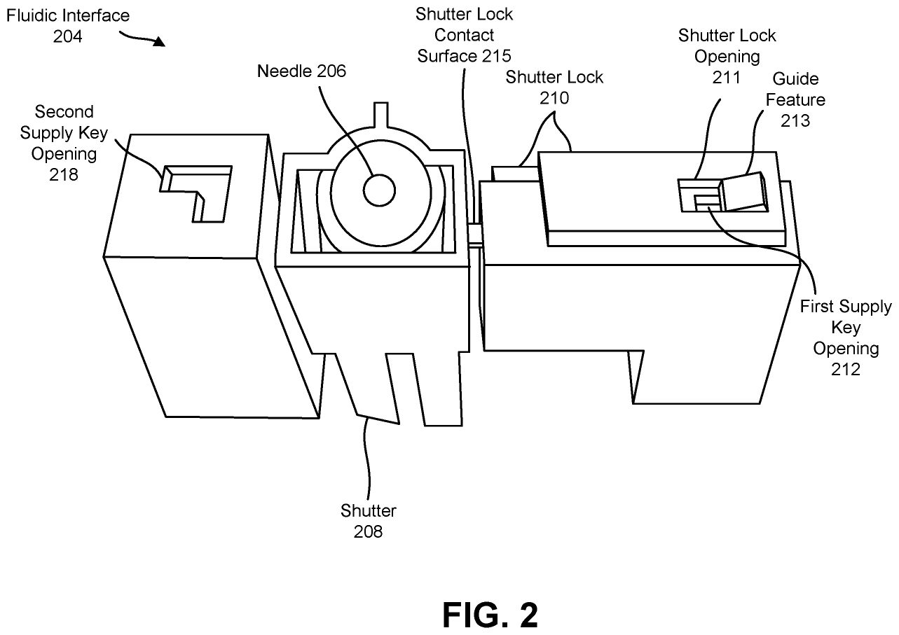

FIG. 2 is an upper perspective view of an example of a fluidic interface 204 of a printing device with a shutter lock 210. The fluidic interface 204 may be implemented in accordance with the fluidic interface 104 described in FIG. 1.

In the example illustrated in FIG. 2, the shutter lock 210 is in an engaged position with the shutter 208. In this case, a shutter lock contact surface 215 projects into toward the shutter 208 to prevent the shutter 208 from retracting from the needle 206. In some examples, the shutter 208 may include an opening or a projection to contact the shutter lock contact surface 215.

In this example, a shutter lock opening 211 is visible. The shutter lock opening 211 may allow the insertion of a supply key into the first supply key opening 212. In this example, the shutter lock opening 211 is positioned to partially block access to the first supply key opening 212. A guide feature 213 may be located next to the shutter lock opening 211 to exert a lateral force on the shutter lock 210 in response to contact by a supply key. Therefore, to insert the supply key into the first supply key opening 212, the shutter lock 210 is first pushed away from the shutter 208 through contact against the guide feature 213. This unlocks the shutter 208, allows the supply key to pass through the first supply key opening 212, and enables the shutter 208 to lower, which eposes the needle 206.

In some examples, the fluidic interface 204 may also include a second supply key opening 218. The second supply key opening 218 may receive a second supply key of the print substance supply. The second supply key opening 218 may facilitate alignment of the fluidic interface 204 on the print substance supply. For example, the combination of the first supply key opening 212 and the second supply key opening 218 may ensure that the print substance supply is centered on the needle 206.

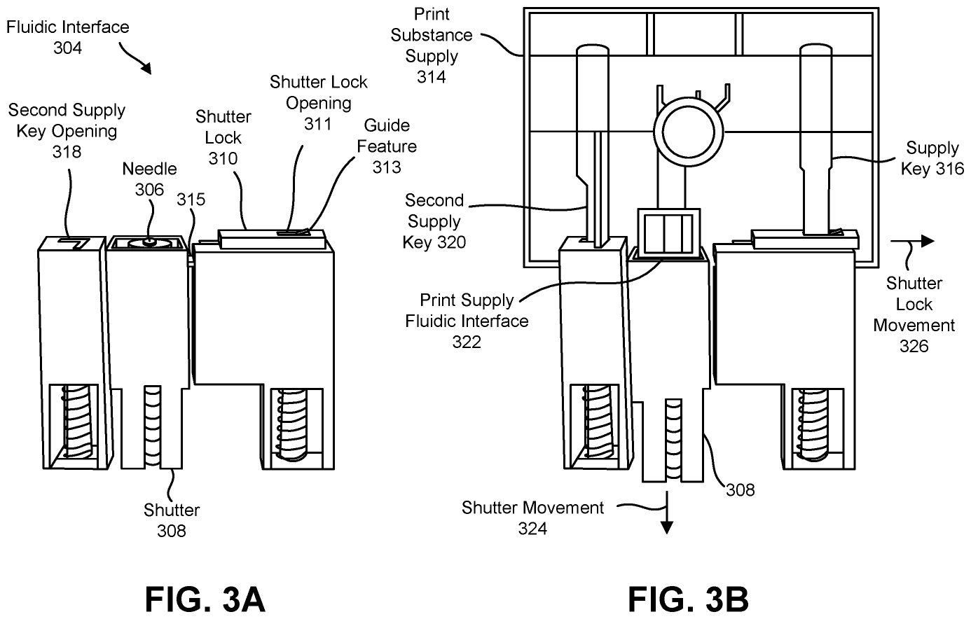

FIGS. 3A and 3B are front perspective views of an example of a fluidic interface 304 of a printing device 302 with a shutter lock 310. The fluidic interface 304 may be implemented in accordance with the fluidic interface 104 described in FIG. 1.

In FIG. 3A, the shutter lock 310 is in an engaged position with the shutter 308. In this case, the shutter 308 is prevented from retracting from the needle 306 by the shutter lock contact surface 315. It should be noted that the second supply key opening 318 is visible in FIG. 3A. However, the first supply key opening is obscured by the shutter lock 310. The shutter lock 310 may include a shutter lock opening 311 to allow a supply key 316 to be inserted into the first supply key opening. Contact by the supply key against the guide feature 313 may cause the shutter lock 310 to slide away from the shutter 308. Once the shutter lock contact surface 315 clears the shutter 308, the shutter 308 may retract from the needle 306.

FIG. 3B illustrates the shutter lock 310 in a disengaged position with the shutter 308. In this case, the first supply key 316 of the print substance supply 314 has been inserted into the first supply key opening through the shutter lock opening 311. The first supply key 316 has shifted the shutter lock 310 away from the shutter 308 to unlock the shutter 308. The shutter lock movement 326 in this example is a lateral movement oriented perpendicular to the direction of the shutter movement 324. A second supply key 320 is also inserted into the second supply key opening 318.

As the supply keys 316, 320 are inserted into the supply key openings, the print supply fluidic interface 322 may contact the shutter 308. This contact may cause the shutter 308 to retract from the needle 306, which protrudes into the print supply fluidic interface 322 to create a fluidic connection.

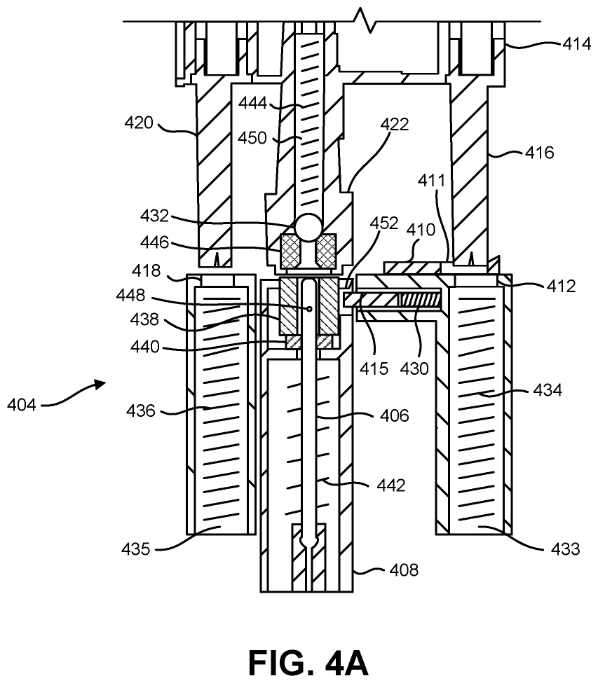

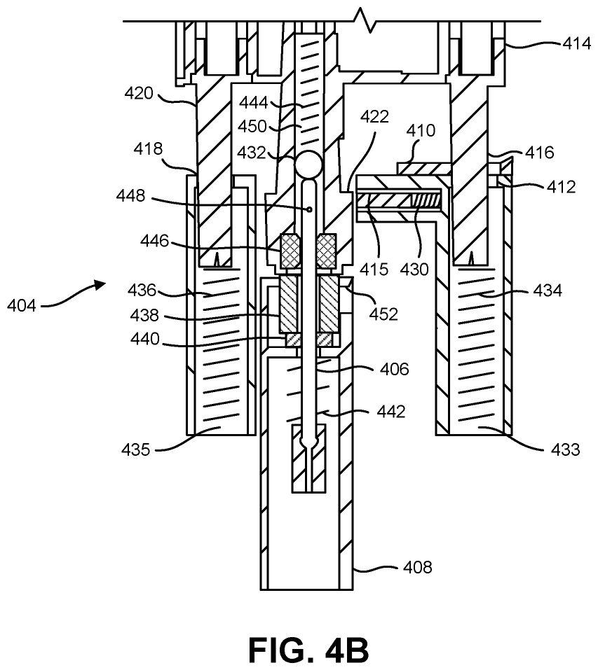

FIGS. 4A and 4B are section views of an example of a fluidic interface 404 with a sliding shutter lock 410. The fluidic interface 404 may be implemented in accordance with the fluidic interface 104 described in FIG. 1.

In FIG. 4A, the shutter lock 410 is in an engaged position with the shutter 408. The shutter lock 410 may engage the shutter 408 to prevent (or limit) movement of the shutter 408 and disengage from the shutter 408 to allow the shutter 408 to retract from the needle 406. In other words, the shutter lock 410 may prevent movement of the shutter 408 covering the needle 406.

A spring 430 forces the shutter lock 410 to engage with the shutter 408. The spring 430 may be a compression spring that compresses as the shutter lock 410 slides away from the shutter 408. In this example, the shutter 408 includes a shutter contact surface 452 to interface with a contact surface 415 of the shutter lock 410 when the shutter lock 410 is in the engaged position.

The supply key opening 412 may receive a supply key 416 attached to the print substance supply 414. The supply key opening 412 facilitates contact of the shutter lock 410 by the supply key 416 as the supply key 416 is inserted in the supply key opening 412. The contact may cause the shutter lock 410 to disengage from the shutter 408. In an example, the shutter lock 410 may include a shutter lock opening 411 through which the supply key 416 may pass into the supply key opening 412.

The fluidic interface 404 may include a cavity 433 to allow the supply key 416 to be inserted into the supply key opening 412. In some examples, the cavity 433 may house a spring 434 that exerts a force against the supply key 416 as the supply key 416 is inserted into the cavity 433.

A second supply key opening 418 may allow a second supply key 420 to be inserted into a cavity 435 of the fluidic interface 404. The cavity 435 may house a spring 436 that exerts a force against the second supply key 420 as the second supply key 420 is inserted into the cavity 435.

In some examples, the shutter 408 may retractably cover the needle 406. For example, the shutter 408 may surround the needle 406 in a first position. In some examples, the shutter 408 may include a circular sleeve 440 and a collar 438 to seal the needle 406 at the print supply fluidic interface 422. A spring 442 may exert a force against the shutter 408 to position the shutter 408 over the needle 406 when the print substance supply 414 is disengaged from the fluidic interface 404.

In FIG. 4B, the shutter lock 410 is in a retracted position. In this case, the shutter lock 410 slides away from the shutter 408 in response to contact of the shutter lock 410 by the supply key 416. As the supply key 416 and the second supply key 420 are inserted into the supply key opening 412 and the second supply key opening 418, the print supply fluidic interface 422 presses against the shutter 408. The shutter 408 moves to retract from the needle 406 and the needle 406 enters the print supply fluidic interface 422.

In some examples, the print supply fluidic interface 422 may include a seal 446 and a ball 432 located within a fluid cavity 450. The seal 446 may engage the needle 406 to prevent the print substance from leaking out of the print supply fluidic interface 422. A spring 444 may force the ball 432 to press against the seal 446 to prevent leakage when the print substance supply 414 is disengaged from the fluidic interface 404. The needle 406 may push against the ball 432 to enter the fluid cavity 450. The needle 406 may include a fluid port 448 to allow the print substance to enter the hollow needle 406 and flow into the printing device 102.

FIG. 5 is a section view of an example of a fluidic interface 504 with a rotational shutter lock 510. The fluidic interface 504 may be implemented as described in FIGS. 4A and 4B. For example, the shutter 508 may retractably cover the needle 506.

In this example, the shutter lock 510 is attached at an axis of rotation 556, which allows the shutter lock 510 to rotate. The axis of rotation 556 may be a pivot point that facilitates rotational motion 558 of the shutter lock 510. In some examples, a spring (not shown) may force the shutter lock 510 to an engaged position with the shutter 508. While in the engaged position, a contact surface 554 of the shutter lock 510 may contact a contact surface 552 of the shutter 508 if a force is exerted on the shutter 508 to cause the shutter 508 to retract. In other words, contact of the shutter 508 by the shutter lock 510 may prevent or limit movement of the shutter 508.

As the supply key 516 of the print substance supply 514 is inserted into the supply key opening 512, the supply key 516 may contact the shutter lock 510. The shutter lock 510 may rotate to retract (e.g., disengage) from the shutter 508 in response to the contact of the shutter lock 510 by the supply key 516. Upon disengaging from the shutter 508, the shutter 508 may retract from the needle 506. The needle 506 may then engage the print substance supply 514 as described in FIGS. 4A and 4B.

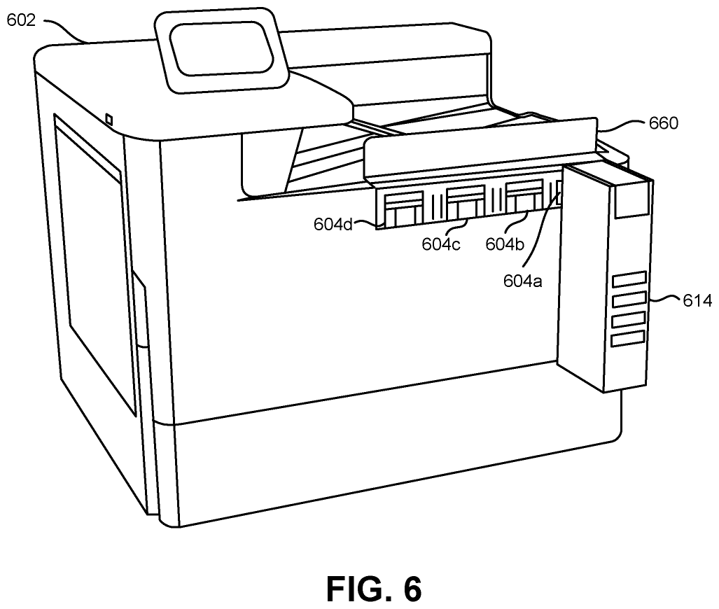

FIG. 6 illustrates an example of a printing device 602 with a plurality of fluidic interfaces 604a-d. In this example, the printing device 602 includes four fluidic interfaces 604a-d coupled to separate print substance reservoirs. The four fluidic interfaces 604a-d may be used to receive a print substance from a print substance supply 614. For example, the first fluidic interface 604a may receive a print substance of a first color, the second fluidic interface 604b may receive a print substance of a second color, and so forth.

It should be noted that three fluidic interfaces 604b-d are exposed and one fluidic interface 604a is covered by the removable print substance supply 614 in FIG. 6. In this example, a cover 660 may pivot to reveal or conceal the fluidic interfaces 604a-d.

As described above, each fluidic interface 604 may include a shutter lock to prevent movement of the shutter covering the needle of the fluidic interface 604. Additionally, a given fluidic interface 604 may include a supply key opening to differentiate supply keys associated with different print substance supply types. For instance, the first fluidic interface 604a may have a supply key opening corresponding to a supply key of a first color, the second fluidic interface 604b may have a supply key opening corresponding to a supply key of a second color, and so forth.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A fluidic interface for a printing device, comprising:
a shutter lock to prevent movement of a shutter covering a needle to engage a print substance supply; and
a supply key opening to receive a supply key of the print substance supply that engages the shutter lock to permit movement of the shutter to expose the needle.

2. The fluidic interface of claim 1, wherein the print substance supply comprises a removable external reservoir to supply a print substance to the printing device.

3. The fluidic interface of claim 1, wherein the shutter lock is spring-loaded to engage the shutter to prevent the shutter from exposing the needle.

4. The fluidic interface of claim 1, wherein contact of the shutter lock by the supply key causes the shutter lock to retract from the shutter to permit movement of the shutter to expose the needle.

5. The fluidic interface of claim 1, wherein the supply key opening is positioned to allow the supply key to move the shutter lock away from the shutter as the supply key is inserted in the supply key opening.

6. A fluidic interface for a printing device, comprising:
a needle to engage a print substance supply;
a shutter to retractably cover the needle;
a shutter lock to engage the shutter to prevent movement of the shutter and disengage from the shutter to allow the shutter to retract from the needle; and
a supply key opening to receive a supply key attached to the print substance supply, the supply key opening to facilitate contact of the shutter lock by the supply key as the supply key is inserted in the supply key opening, the contact causing the shutter lock to disengage from the shutter.

7. The fluidic interface of claim 6, wherein the shutter lock slides away from the shutter in response to the contact of the shutter lock by the supply key.

8. The fluidic interface of claim 7, wherein the supply key opening is positioned at least partially under the shutter lock when the shutter lock engages the shutter, and wherein the contact of the shutter lock by the supply key causes the shutter lock to slide away and expose the supply key opening to the supply key.

9. The fluidic interface of claim 6, wherein the shutter lock rotates to retract from the shutter in response to the contact of the shutter lock by the supply key.

10. The fluidic interface of claim 6, further comprising a second supply key opening to receive a second supply key of the print substance supply, the second supply key opening to facilitate alignment of the fluidic interface on the print substance supply.

11. A printing device, comprising:
a print substance reservoir; and
a fluidic interface coupled to the print substance reservoir, the fluidic interface to create a fluidic connection with an external print substance supply, the fluidic interface comprising:
a needle to engage the print substance supply;
a shutter lock to prevent movement of a shutter covering a needle; and
a supply key opening to receive a supply key attached to the print substance supply, the supply key opening to facilitate contact of the shutter lock by the supply key as the supply key is inserted in the supply key opening, the contact causing the shutter lock to disengage from the shutter and allow the shutter to retract from the needle.

12. The printing device of claim 11, wherein the print substance reservoir stores a print substance for a continuous ink supply system (CISS).

13. The printing device of claim 11, wherein the supply key opening comprises geometry to differentiate supply keys associated with different print substance supply types.

14. The printing device of claim 13, wherein the supply key opening receives a supply key having a geometry that is compatible with the geometry of the supply key opening.

15. The printing device of claim 11, further comprising a plurality of fluidic interfaces coupled to a plurality of print substance reservoirs, wherein each fluidic interface includes a supply key opening having a geometry that differs from other supply key openings to differentiate supply keys associated with different print substance supply colors.
